(19) United States
(12) Patent Application Publication
(10) Pub. No.: US 2006/0028428 A1
(43) Pub. Date: Feb. 9, 2006

(54) Handheld device having localized force feedback

(76) Inventors: Xunhu Dai, Gilbert, AZ (US); Manuel Oliver, Scottsdale, AZ (US); Daniel J. Sadler, Gilbert, AZ (US); Chia-Yu Fu, Chandler, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/912,978

(22) Filed: Aug. 5, 2004

(51) Int. Cl. G09G 5/00

(52) U.S. Cl. 345/156

(57) ABSTRACT

An electronic device (100) for performing intelligent operations includes a housing (112), a manually operable input (118, 122) for providing information to the electronic device, and a material (124) positioned between the manually operable input and the housing. An electromechanical transducer (218, 220) has a mechanical connection consisting of to the manually operable input and an electrical connection for receiving power, wherein substantially all of a mechanical output from the electromechanical transducer is provided to the manually operable input, the material preventing the mechanical output from being transmitted from the manually operable input to the housing. An electric circuit (210) is coupled mechanically to the housing and electronically to the electromechanical transducer for driving the electromechanical transducer in response to the intelligent operations so as to cause the electromechanical transducer to generate a tactile response that can be felt by a user through the manually operable input.

### FIELD OF INVENTION

The present invention generally relates to manually operable controls for electronic devices and more particularly to a device for providing active, content related tactile force feedback to the user of electronic devices.

### BACKGROUND OF THE INVENTION

In the past decade a variety of electronic devices, including portable electronic devices have come into wide spread use. In the design of electronic devices that are portable, emphasis is placed on reducing the space occupied by each individual component, and reducing the cost. The former consideration leads to selection of keys that have a small stroke (distance the key moves when actuated). Unfortunately, such keys do not provide active tactile force feedback, a sense of touch sometimes called haptics, to a user operating the keys. This is particularly problematic if a user is in the habit of actuating a sequence of keys in rapid succession, in the case of user having reduced manual dexterity (e.g., an elderly user), or in the case of a visually impaired user.

Dome switches which abruptly displace when a certain threshold manual actuation force is exceeded, have been used. Although such switches provide a degree of tactile feedback, they have complex structures, and commensurate cost. Elastomeric switches are a type of low cost, but also low stroke, switch. Regrettably, elastomeric switches provide little tactile feedback. This type of feedback is generally classified as passive since one could only feel the feedback when a switch is pressed. In addition, this type of feedback is generally not content related.

Given the rapid introduction of new types of device (e.g., Personal Digital Assistants, Text messaging pagers, MP3 players), and the rapid development of novel functionality, another important objective in designing electronic devices is to provide intuitive interfaces. Employing touch screens along with graphical user interfaces (GUI) is one avenue to providing intuitive interfaces. A touch screen is typically firmly mounted to device housing. Consequently, the stroke of touch screens is frequently so small as to be imperceptible, and therefore touch screens provide little if any tactile feedback.

Devices more recently are actively responding to user input by providing tactile cues or responses to the user. The vibrator in a cell phone or pager is a good example. Other examples include an input key that provides a clicking sound when moved; a key or touch screen that moves suddenly or vibrates, in an opposed direction to the input; and a key that moves suddenly or vibrates perpendicular to the direction of input in response to a transducer attached to the housing. However, all the devices mentioned here have the device supplying the sudden movement or vibration mounted on the device housing, causing a vibration in the housing and resulting in a reduced or confusing sensation to the user.

### SUMMARY OF THE INVENTION

In various exemplary and representative aspects, one embodiment of the present invention provides an electronic device for performing intelligent operations including a housing, a manually operable input for providing information to the electronic device, and a material positioned between the manually operable input and the housing. An electromechanical transducer has a physical connection consisting of being mechanically connected to the manually operable input, wherein substantially all of a mechanical output from the electromechanical transducer is provided to the manually operable input, the material preventing the mechanical output from being transmitted from the manually operable input to the housing. An electric circuit is coupled mechanically to the housing and electronically to the electromechanical transducer for driving the electromechanical transducer in response to the intelligent operations so as to cause the electromechanical transducer to generate a tactile response that can be felt by a user through the manually operable input.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside in the details of construction and operation as more fully hereafter depicted, described and claimed-reference being made to the accompanying drawings forming a part hereof, wherein like numerals refer to like parts throughout. Other elements, operational features, applications and/or advantages will become apparent to skilled artisans in light of certain exemplary embodiments recited in the Detailed Description, wherein:

FIG. 1 is a front view of an electronic device according to the preferred embodiment of the invention;

FIG. 2 is a sectional side view of the electronic device shown in FIG. 1;

FIG. 3 is an exploded cut away view of another embodiment of a switch used in the wireless communication device shown in FIGS. 1 and 2;

FIG. 4 is an exploded cut away view of yet another embodiment of a switch used in the wireless communication device shown in FIGS. 1 and 2;

FIG. 5 is a block diagram of the electronic device shown in FIGS. 1 and 2 according to the preferred embodiment of the invention; and

FIG. 6 is a flow diagram of a method for operating the electronic device shown in FIGS. 1 and 2 according to the preferred embodiment of the invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention.

Furthermore, the terms ‘first’, ‘second’, and the like herein, if any, are used for distinguishing between similar elements and not necessarily for describing a sequential or chronological order. Moreover, the terms front, back, top, bottom, over, under, and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

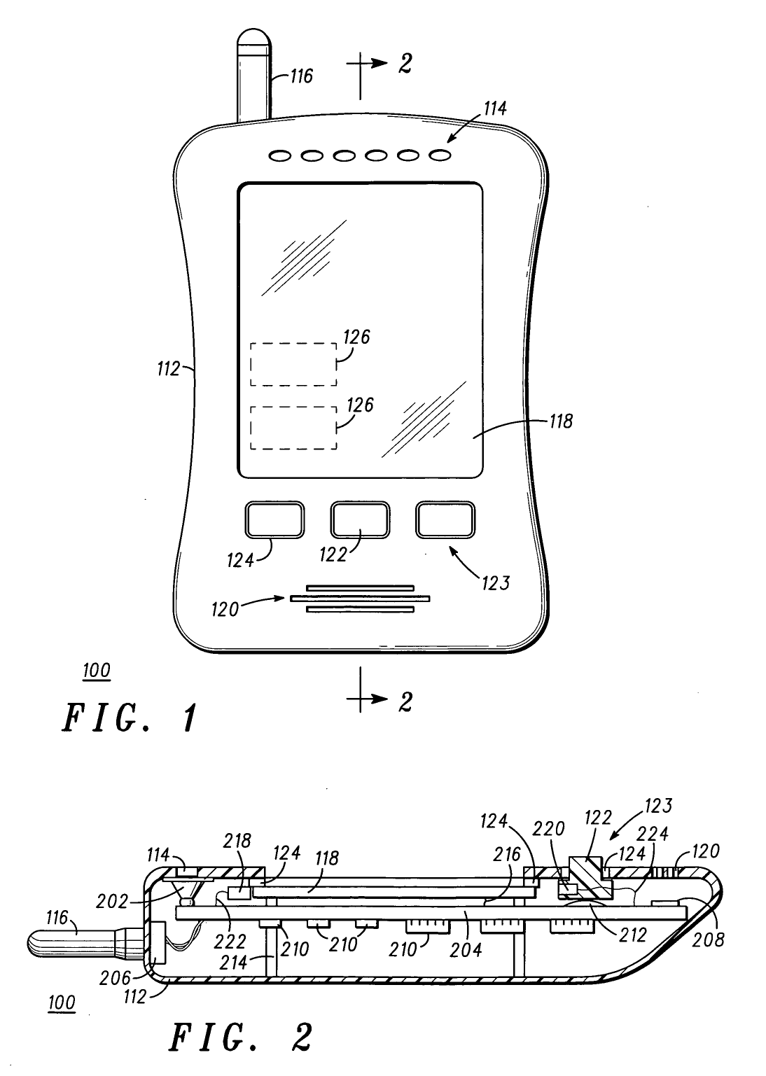

FIG. 1 is a front view of an electronic device according to the preferred embodiment of the invention and FIG. 2 is a sectional side view of the electronic device shown in FIG. 1. As shown in FIGS. 1 and 2, the electronic device comprises a telephone 100, although it should be understood that it could alternatively comprise other types of electronic devices such as a hand-held game, a Personal Digital Assistant, or a pager. Such alternative devices may not include all the elements, such as an antenna or speaker, shown on the telephone 100. The telephone 100 and all such alternative devices comprise electronics that performs intelligent operations. The telephone 100, as shown, includes a housing 112. The housing 112 includes an audio output grid 114, overlying a speaker 202 attached to a circuit board 204. An antenna 116 is provided for receiving and transmitting RF communication signals and is attached to the housing 112, for example, by a nut 206. A display 118 is provided for displaying information, such as stored telephone numbers, and caller ID information to a user. An audio input aperture grid 120 is provided for coupling sound including a user's utterances to a microphone 208. The circuit board 204 supports and electrically couples circuit components 210 that make up one or more electrical circuits that are part of the telephone 100. The circuit board 204 also supports the speaker 202, and the microphone 208. The telephone 100 includes one or more keys 122, or buttons, that may control any of several functions such as menu selection, navigation, and data input. The keys are positioned on a dome switch 212 and are quiet, i.e., they make little or no noise when actuated, have small strokes, e.g., less than one millimeter, and provide only passive tactile feedback by themselves.

The keys 122 protrude through an opening 123 in the housing 112. The display 118 and keys 122 are both cushioned from the housing 112 by a soft material 124, such as silicon rubber, that dampens any vibration from passing to or from the housing 112. The material also serves to prevent dust and moisture from entering into the housing 112. The display 118 is also connecting to housing 112 by arms 214. Arms 214 provide support to the display 118 by maintaining its position against the soft material 124. Arms 214 is substantially rigid along the Z direction (perpendicular to the display plane), but compliant in X, Y directions (in the display plane), allowing the screen 118 to have small lateral displacement to provide haptic feedback to the user.

There are various methods of providing input to a device such as the electronic device 100, including the keys 122 and the display 118. It is well known in the art that displays may comprise “touch screens” wherein a person may touch a spot on the display with a finger or a stylus for providing information to the electronic device. Such contact by a finger or stylus provides an electrical signal through electrical coupling 216.

In accordance with the preferred embodiment, an input mechanism such as the display 118 and/or the key 122 is configured for providing active tactile force feedback. An electromechanical transducer 218, such as a voice-coil based vibration motor, a piezoelectric actuator or vibrator, or the like, is mechanically connected directly to the display 118, and an electromechanical transducer 220, such as a vibrator, or the like, is mechanically connected directly to the key 122. The electromechanical transducer 218 is positioned so the movement provided to the display 118 is in the “x” or “y” direction parallel to the plane of the display 118 (a lateral motion that is perpendicular to the direction in which the user pushes the screen). The electromagnetic transducer 218 may be mounted on the side of display 118, as shown in FIG. 2, or on the back of display 118 (not shown in FIG. 2). The electromechanical transducer 220 may be positioned inside the key 122 as shown in FIG. 2, or in any of several other positions as described later so that the movement provided to the key 122 is in the “x”, “y” or “z” direction or some combination thereof. The electromechanical transducers 218 and 220 serve to convert electrical signals to mechanical movement. By having the electromechanical transducers 218 and 220 connected only to the display 118 and key 122, respectively, little or no vibration is transferred to the housing 112. Electrical connections to the electromechanical transducers 218 and 220 are made to the circuit board 204 by a twisted pair of leads 222 and 224, respectively, or flex circuitry, but such wiring transmits substantially no vibrations to the circuit board 204.

In the state shown in FIG. 1, two virtual keys 126 are presented on the display 118. Although only two virtual keys 126 are shown, it should be understood there could be only one, or several. When a user presses directly, or with a stylus, on a portion of the touch screen overlying one of the virtual buttons 126, the press will be detected and in response thereto the electromechanical transducer 218 will be driven causing the electromechanical transducer 218 to emit mechanical energy that is coupled to the touch screen (and through the stylus if used). The mechanical energy is felt by the user as one or more impulses (a tactile response). The impulse(s) serve to confirm to the user that the intended input has been registered by the telephone 100. In other words, the user receives acknowledgement of the intended input. The electromechanical transducer 218 is preferably driven with a signal that includes one or more sharp steps. Driving the electromechanical transducer 218 with a signal that includes one or more sharp steps causes the touch screen 118 to be jolted. Also any other user-defined wave forms could be used to actuate the electromechanical transducer. The jolt may comprise information based on intelligent operations performed by the circuit components 210. If the telephone 100 was being held by the user, the jolt would only be felt through the display 18 and not the housing 112.

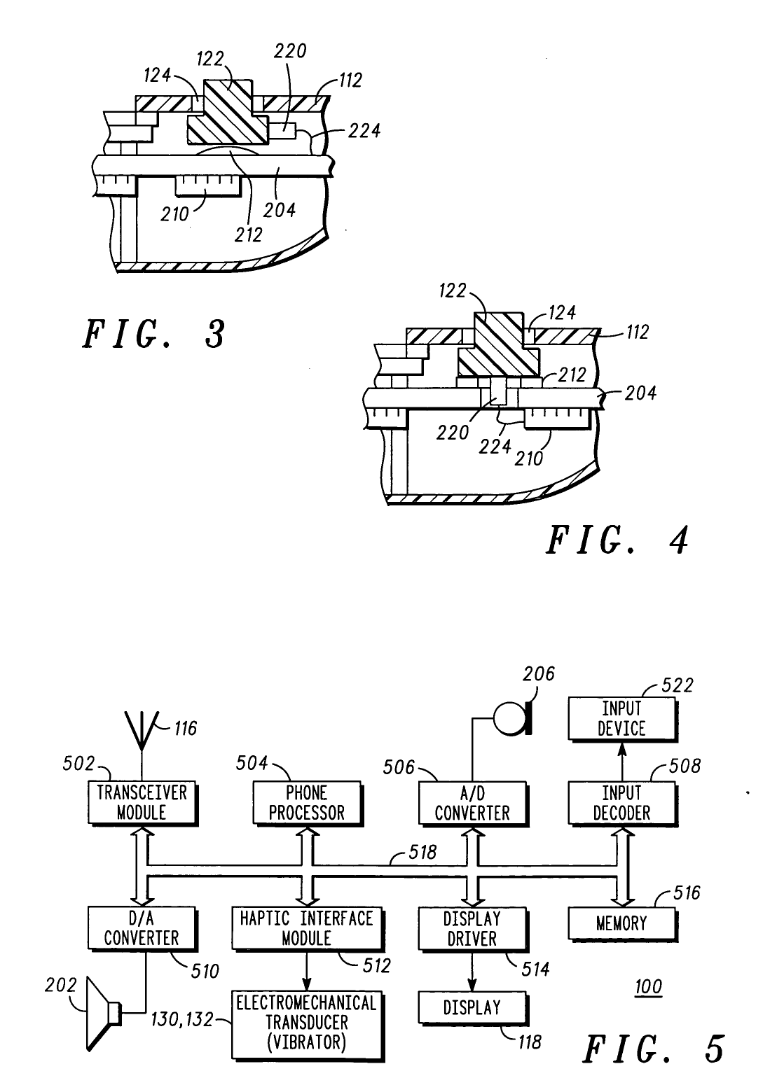

Referring to FIG. 3, an alternative embodiment is illustrated wherein the electromechanical transducer 220 is connected to the side of the key 122. And FIG. 4 illustrates yet another embodiment wherein the electromechanical transducer 220 is connected to the bottom of the key 122 with the electrical connection 128 going through the opening 123 in the circuit board 204.

Referring to FIG. 5, the telephone 100 comprises a transceiver module 502, a phone processor 504, an analog-to-digital converter 506 (A/D), an input decoder 508, a digital-to-analog converter (D/A) 510, a haptic interface module 512, a display driver 514, and a memory module 516 coupled through a digital signal bus 518. The transceiver module 502 is coupled through an antenna 116 to free space. The A/D 506 is coupled to the microphone 208 for receiving audio signals therefrom. The display driver 514 is coupled to the display 118. The D/A 510 is coupled to the speaker 202. The speaker 202 is driven by signals output by the D/A 510.

An input device 522 is coupled to the input decoder 508. When utilizing the keys 122, the input device 522 preferably comprises the keypad 212, and associated metallization (e.g., interdigitated fingers) on the printed circuit board 204. The input decoder 508 serves to identify depressed keys and supply information identifying depressed keys to the phone processor 504. The input decoder 508 is preferably adapted to send an interrupt to the phone processor 504 in response to a key press, and thereafter to provide data identifying a depressed key. Identifying information preferably takes the form of a multibit word that is read by the phone processor 504 in a read operation that is triggered by the interrupt. Rather that using an interrupt, the phone processor 504 can be programmed to periodically read the input decoder 508. The memory module 516 is used to store programs that are executed by the phone processor 504 to control the operation of the telephone 100, including the reading of the input decoder 508.

The haptic interface module 512 is configured to output pulses of predetermined or user defined amplitude and duration in response to receiving a trigger signal from the phone processor 504. Alternatively, other interface logic (e.g., address decoding logic) is included between the digital signal bus 518, and the haptic interface module 512. The phone processor 504 is programmed to trigger the haptic interface module 512 in response to a key press being communicated through the input decoder 508. Optionally, the triggering of the haptic interface module 512 can be selectively enabled or disabled in accordance with configuration settings that a user can edit. The haptic interface module 512 is coupled to the electromechanical transducer 218, 220. The electromechanical transducer 218, 220 is driven by the output of the haptic interface module 512.

More generally, the electromechanical transducer 218, 220 is preferably driven by a signal that includes at least one approximation of a step function. (Note that a step function is a mathematical ideal that no real world circuit can achieve). A step function includes a broad range of frequencies. By using a driving signal that includes an approximation of a step function, the electromechanical transducer 132 is caused to emit an impulse of mechanical energy that propagates to the keypad 212 and is felt by a user operating the telephone 100. More preferably, the electromechanical transducer 218, 220 is driven by a signal that includes one or more pulses. Preferably, a single pulse is generated in response to each detected key press. Using a single pulse is advantageous in that a single pulse generates an impulse of mechanical energy that creates a tactile sensation that simulates the feel of previously known keys with which the user may be familiar.

The transceiver module 502, phone processor 504, A/D 506, input decoder 508, D/A 1010, haptic interface module 512, display driver 514, memory 516, and display driver 514 are preferably part of an electric circuit that is embodied in the circuit components 210, and interconnecting traces of the circuit board 204.

Alternatively in lieu of using the phone processor 504, a different electric circuit may be used to drive the electromechanical transducer 218, 220 in order to generate tactile feedback for the display 118.

Alternatively, the input device 522 may comprise a display 118 when using either a telephone, pager, or personal digital assistant. Alternatively, an acoustic, or analog type touch screen can be used. In the personal digital assistant, the input decoder 508 would be replaced by a type of decoder suitable to the type of touch screen that is used. Certain components such as the microphone 208, and speaker 202, can be absent in the case of the personal digital assistant.

The haptic interface module 512 could alternatively be a pulse generator, generating digital pulses of various widths, heights, and/or frequencies based on instructions from the phone processor 504. Depending on the impedance match to the electromechanical transducers 218, 220 and current sourcing/sinking capability, an amplifier may be needed. Alternatively, the haptic interface module 512 could simply be a current amplifier and pulses would be generated by the phone processor 504 itself.

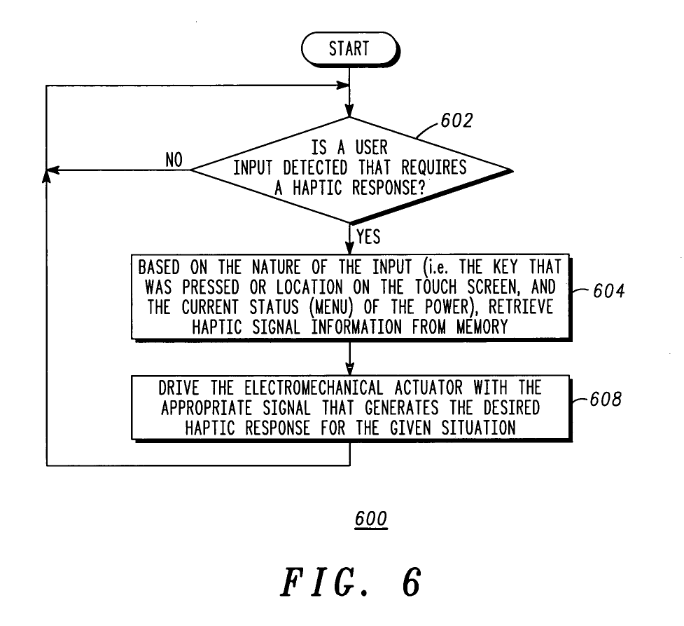

FIG. 6 is a flow diagram 600 of a method for operating the wireless communication device shown in FIGS. 1 through 5 according to the preferred embodiment of the invention. Block 602 is a decision block that depends on whether the user's actuation of a manually operable input has been detected. If not the flow diagram 600 continually loops back and awaits the actuation of the manually operable input. In the case of the telephone 100, the manually operable input takes the form of the keys 122 or the touch screen 118. When actuation of the manually operable input is detected, the flow diagram 600 progresses to step 604 in which haptic signal information is retrieved from memory based on the nature of the input. Once this information is retrieved, the electromechanical transducer 218, 220 is driven to produce tactile feedback.

### EXAMPLE 1

The user has accessed an address in the electronic device 100 and presses “up” on a navigation key 122. The image on the display 118 changes (via the display 514) to indicate the selection of the highlighted name in the address book (one up from the previous position). Simultaneously, haptic feedback is provided to the navigation key 122 to indicate the new selection. The feedback could take the form of a single pulse or multiple pulses, and the pulse(s) could occur in any one of the x, y, or z direction (depending on which way the electromechanical transducer 220 was positioned).

### EXAMPLE 2

The user wishes to return to a main menu on the display 118 and presses either one of a virtual key 126 or a key 122 designated to select the main menu. The processor 504 recognizes this selection and changes the display 118 via the display driver 514. Simultaneously, haptic feedback is provided either to the display 118 if the virtual key 126 was used, or the key 122 if that key was used. The feedback could take the form of a single pulse or multiple pulses in the “x” or “y” direction for the display 118 (depending on which way the electromechanical transducer 218 was positioned) or any one of the “x”, “y”, or “z” directions or some combination thereof for the key 122 (depending on which way the electromechanical transducer 220 was positioned).

Various embodiments could include multiple impulse responses. For example, each key 122 or virtual key 126 could be designed to have a different feel so the user would know which virtual key his finger was touching without looking at the electronic device 100. Also, specific names in an address book could be assigned special haptic responses (such as multiple pulses vs. a single pulse for most names) for a spouse, friend, or the like. In each instance, when the phone processor 504 receives an input for a certain status, it would select the appropriate response from memory 516 and transfer that information to the haptic interface module 512 for generating the response.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1. An electronic device comprising:
a housing;
a manually operable input for providing information to the electronic device wherein intelligent operations are being preformed;
an electromechanical transducer having a mechanical connection consisting of the manually operable input, and an electrical connection for receiving power, wherein substantially all of a mechanical output from the electromechanical transducer is provided to the manually operable input; and
an electric circuit coupled mechanically to the housing and electronically to the manually operable input and the electromechanical transducer for driving the electromechanical transducer in response to the intelligent operations so as to cause the electromechanical transducer to generate a tactile response that can be felt by a user through the manually operable input, wherein substantially none of the mechanical output is provided to the housing.

2. The electronic apparatus of claim 1 wherein the manually operable input is a key.

3. The electronic apparatus of claim 1 wherein the electromechanical transducer causes the key to move in one of the x, y, and z directions or some combination thereof.

4. The electronic apparatus of claim 1 wherein the manually operable input is a plurality of keys.

5. The electronic apparatus of claim 1 wherein the manually operable input is a navigational key.

6. The electronic apparatus of claim 1 wherein the manually operable input is a touch screen.

7. The electronic apparatus of claim 1 wherein the manually operable input comprises one or more locations on a touch screen.

8. The electronic device of claim 1 wherein the mechanical output comprises one or more types, each type representing different information provided by the intelligent operations.

9. The electronic device of claim 8 wherein the mechanical output representing different types is previously defined by the user.

10. The electronic device of claim 1 wherein the electric circuit comprises one or more of a phone, a personal digital assistant, a pager, and a gaming device.

11. An electronic device for performing intelligent operations, comprising:
a housing;
a manually operable input for providing information to the electronic device;
a material positioned between the manually operable input and the housing;
an electromechanical transducer having a mechanical connection consisting of the manually operable input and an electrical connection for receiving power, wherein substantially all of a mechanical output from the electromechanical transducer is provided to the manually operable input and the material preventing the mechanical output from being transmitted from the manually operable input to the housing; and
an electric circuit coupled mechanically to the housing and electronically to the electromechanical transducer for driving the electromechanical transducer in response to the intelligent operations so as to cause the electromechanical transducer to generate an tactile response that can be felt by a user through the manually operable input.

12. The electronic apparatus of claim 11 wherein the manually operable input is a key.

13. The electronic apparatus of claim 12 wherein the electromechanical transducer causes the key to move in one of the x, y, and z directions.

14. The electronic apparatus of claim 11 wherein the manually operable input is a plurality of keys.

15. The electronic apparatus of claim 11 wherein the manually operable input is a navigational key.

16. The electronic apparatus of claim 11 wherein the manually operable input is a touch screen.

17. The electronic apparatus of claim 16 wherein the mechanical output is provided in a direction in a plane to the touch screen.

18. The electronic apparatus of claim 16 wherein the manually operable input comprises one or more locations on the touch screen.

19. The electronic device of claim 11 wherein the mechanical output comprises one or more types, each type representing different information provided by the intelligent operations.

20. The electronic device of claim 19 wherein the mechanical output representing different types is previously defined by the user.

21. The electronic device of claim 11 wherein the electric circuit comprises one or more of a phone, a personal digital assistant, a pager, and a gaming device.
